(19) United States
(12) Patent Application Publication
(10) Pub. No.: US 2010/0057967 A1
(43) Pub. Date: Mar. 4, 2010

(54) RECORDING MEDIUM WITH LOAD DISTRIBUTION PROGRAM RECORDED THEREIN AND LOAD DISTRIBUTION APPARATUS

(75) Inventors: Takeo MURAKAMI, Kawasaki (JP); Tatsuya Yanagisawa, Kawasaki (JP); Shunpei Nishikawa, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/541,260

(22) Filed: Aug. 14, 2009

(30) Foreign Application Priority Data
Aug. 27, 2008 (JP) 2008-218431

(51) Int. Cl. G06F 13/26; G06F 13/24

(52) U.S. Cl. 710/264; 710/267

(57) ABSTRACT

A recording medium with a load distribution program recorded therein for causing a computer system to execute the following processing includes: acquiring, at every first timing, a processor load status and an input/output device load status; referencing, at every second timing, a load distribution policy and a load distribution executing condition for distributing interrupts and using the processor usage rate by the application job; determining whether a processor satisfying the load distribution initiating condition is present; referencing the processor load statuses and input/output device load statuses when a processor satisfying the load distribution initiating condition is present; calculating processor usage rates of all input/output devices interrupting the processor; determining a processor and an input/output device satisfying the load distribution executing condition based on the calculated processor usage rate; and changing the interrupt destination processor of the input/output device satisfying the load distribution executing condition.

### CROSS-REFERENCE TO RELATED APPLICATIONS

This application is based upon and claims the benefit of priority of the prior Japanese Patent Application No. 2008-218431, filed on Aug. 27, 2008, the entire contents of which are incorporated herein by reference.

### FIELD

The present invention relates to a load distribution technique for distributing interrupts from input/output devices among processors, in a multiprocessor-type computer system.

### BACKGROUND

In the multiprocessor-type computer system, load distribution control to distribute interrupts from input/output devices such as Ethernet® and SCSI (small computer system internet) among processors is being performed. As a method for load distribution control, a technique for dynamically distributing interrupts among the processors has been proposed, wherein statistical information on processor usage rates or bind process numbers is held, and based on this statistical information, an application operation or an OS (operating system) status is taken into consideration (refer to, for example, Japanese Laid-open Patent Publication No. 11-7429).

However, in such a conventional proposed technique, because load distribution control has been performed in response to load statuses of processors at a particular point in time, an appropriate load distribution effect has not been exerted, for example, in such a way that load is unevenly distributed toward a few of the processors after load distribution. This presents a potential problem of degrading performance of a computer system.

### BRIEF DESCRIPTION OF THE DRAWINGS

FIG. 1 illustrates a load distribution apparatus according to an embodiment the present invention;

FIG. 2 illustrates the configuration of a CPU statistical information table;

FIG. 3 illustrates the configuration of an I/O statistical information table;

FIG. 4 illustrates a logical configuration of a load distribution policy;

FIG. 5 is a diagram explaining of an implementation method for the load distribution policy;

FIG. 6 is a flowchart illustrating content of statistical processing;

FIG. 7 is a flowchart illustrating content of load distribution processing;

FIG. 8 is another flowchart illustrating content of load distribution processing;

FIG. 9 is a flowchart illustrating content of subroutine performing a load distribution predication;

FIG. 10 is a diagram explaining processor load statuses as a prerequisite to a first example in the present invention;

FIG. 11 is a diagram explaining input/output device load statuses as a prerequisite to the first example;

FIG. 12 is a diagram explaining a load distribution policy 1 as a prerequisite to the first example;

FIG. 13 is a diagram explaining processor load statuses updated by load distribution processing;

FIG. 14 is a diagram explaining input/output device load statuses updated by load distribution processing;

FIG. 15 is a diagram illustrating effects of a load distribution implementation.

FIG. 16 is a diagram explaining processor load statuses as a prerequisite to a second example in the present invention;

FIG. 17 is a diagram explaining input/output device load statuses as a prerequisite to the second example; and

FIG. 18 is a diagram explaining the load distribution policy 1 as a prerequisite to the second example.

### SUMMARY

According to an aspect of the embodiment, a recording medium with a load distribution program recorded therein for a computer system including a plurality of processors and a plurality of input/output devices, the program causing the computer to execute:

acquiring, at every first timing, for each of the processors, a processor load status including a processor usage rate of an application job, a processor usage rate of an interrupt from at least one of the input/output devices, and a processor usage rate increasing/decreasing tendency; and, for each of the input/output devices, acquiring an input/output device load status including an interrupt destination processor and an accumulated number of times of interrupts;

referencing, at every second timing, a load distribution policy that defines a load distribution initiating condition and a load distribution executing condition for distributing interrupts from at least one of the input/output devices among the processors, using the processor usage rate of the application job, the processor usage rate of the interrupts from the at least one of the input/output devices, and the processor usage rate increasing/decreasing tendency; and determining whether or not a processor satisfying the load distribution initiating condition is present based on the processor load status;

referencing the processor load statuses and input/output device load statuses when a processor satisfying the load distribution initiating condition is present; calculating processor usage rates of all the input/output devices interrupting the processor; and determining a processor and an input/output device satisfying the load distribution executing condition based on the calculated processor usage rate; and

changing the interrupt destination processor of the input/output device satisfying the load distribution executing condition.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

In a computer system including a plurality of processors and a plurality of input/output devices, a processor load status including a processor usage rate based on the number of application jobs, a processor usage rate based on the number of interrupts from at least one of the input/output devices, and a processor usage rate increasing/decreasing tendency, is acquired at a first timing. Similarly, an input/output device load status, including an interrupt destination processor and an accumulated number of times of interrupts, is also acquired at every first timing. Furthermore, at a second timing, a load distribution policy that defines a load distribution initiating condition and a load distribution executing condition for distributing interrupts from at least one of the input/output devices among processors, is referenced to determine whether a processor satisfying the load distribution initiating condition is present or not based on the processor load status. If a processor satisfying the load distribution initiating condition is present, the processor load statuses and the input/output device load statuses are referenced to calculate processor usage rates of all the input/output devices interrupting the processor, and to determine a processor and an input/output device satisfying the load distribution executing condition based on the processor usage rate. Then, the interrupt destination processor of the input/output device satisfying the load distribution executing condition is changed.

Since a processor as a load distribution target and an input/output device are determined based on a simulation result that predicts a processor load after load distribution, an uneven distribution of loads toward only a few processors may be avoided, thereby reducing performance degradation of the computer sysytem.

Hereinafter, embodiments according to the present invention will be described in detail with reference to the appended drawings.

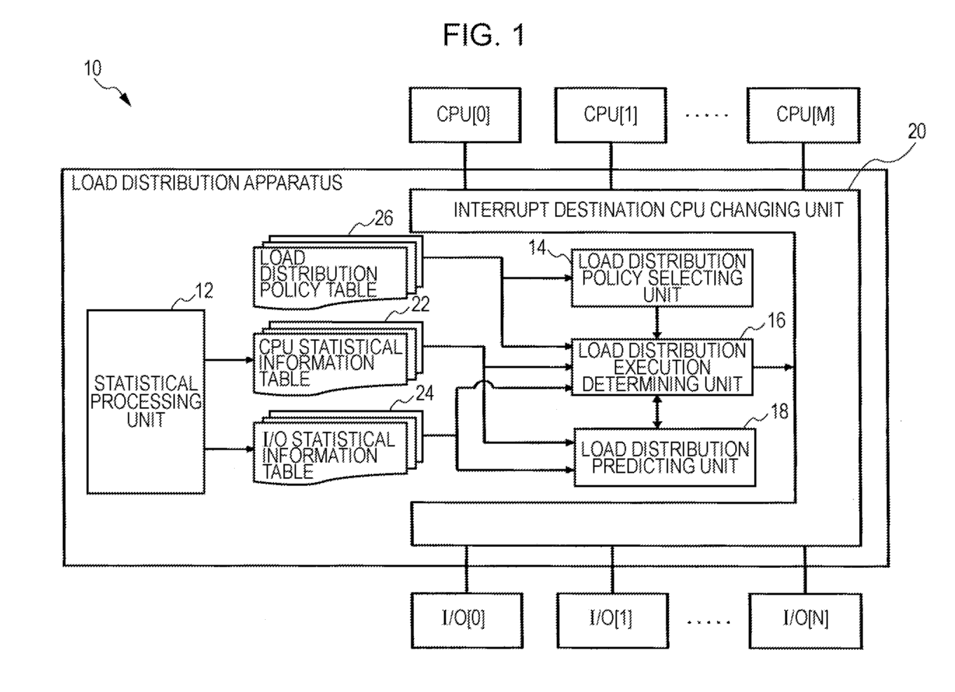

FIG. 1 illustrates an embodiment of a load distribution apparatus of the present invention.

The load distribution apparatus 10 is built in a computer system comprising a plurality of processors CPU [0] to CPU [M] and a plurality of input/output devices I/O [0] to I/O [N]. In the load distribution apparatus 10, by executing a load distribution program installed in an external storage device such as a hard disk in the computer system, a statistical processing unit 12, a load distribution policy selecting unit 14, a load distribution execution determining unit 16, a load distribution predicting unit 18, and an interrupt destination CPU changing unit 20 are implemented. Furthermore, a CPU statistical information table 22, an I/O statistical information table 24, and a load distribution policy table 26 are held in a shared memory of the computer system.

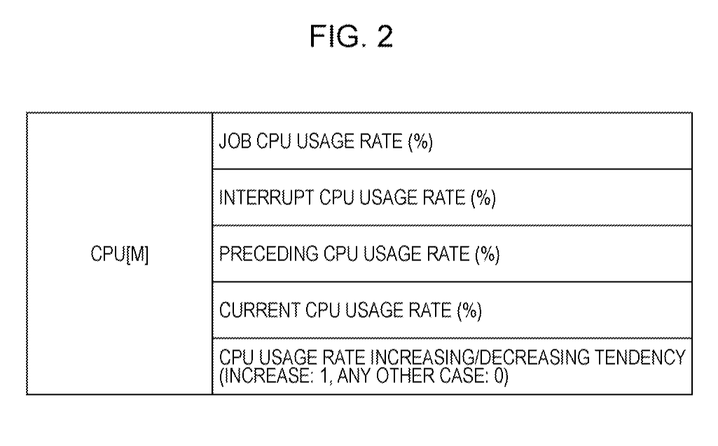

As illustrated in FIG. 2, in the CPU statistical information table 22, a load status is registered for each of the processors. The load status is stored in association with the CPU usage rate based on the number of application jobs (hereinafter, referred to as a “job CPU usage rate”), the CPU usage rate based on the number of input/output interrupts (hereinafter, referred to as an “interrupt CPU usage rate”), the preceding CPU usage rate, the current CPU usage rate, and the CPU usage rate increasing/decreasing tendency. The “job CPU usage rate” indicates the average value of processor usage rates used for processing an application job for a specific time period, that is, a value obtained by dividing an accumulated value of the processor usage rates used for processing the application job by the accumulated number of times. The “interruption CPU usage rate” indicates the average value of processor usage rates used for processing interrupts from each of the input/output devices for a specific time period, that is, a value obtained by dividing an accumulated value of the processor usage rate used for processing the interrupts by the accumulated number of times. The “preceding usage rate” indicates the last processor usage rate (job CPU usage rate and interrupt CPU usage rate) during a statistical information acquisition period. The “current usage rate” indicates the current processor usage rate (job CPU usage rate and interrupt CPU usage rate) during the statistical information acquisition period. If the current usage rate is greater than the preceding usage rate, that is, if the processor usage rate tends to increase, “1” is stored as the “CPU usage rate increasing/decreasing tendency”; otherwise, “0” is stored.

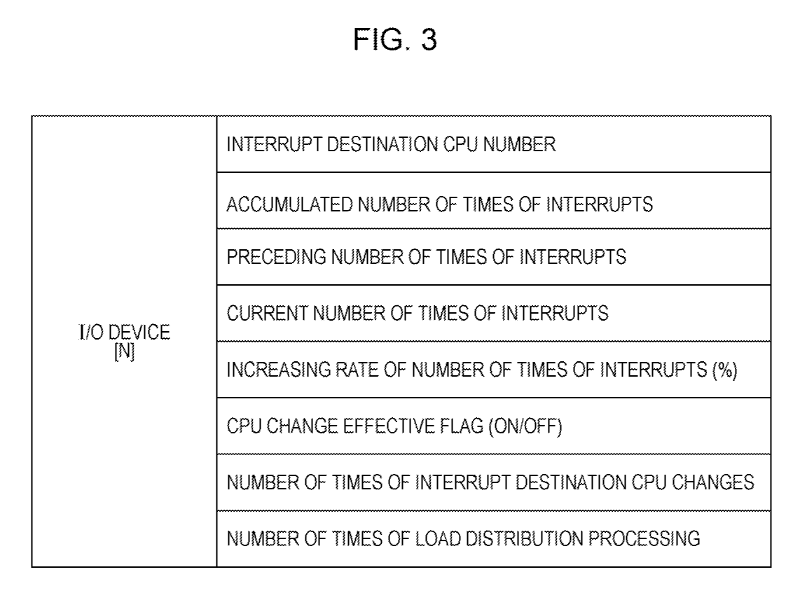

As illustrated in FIG. 3, in the I/O statistical information table 24, a load status is registered for each of the input/output devices. The load status is stored in association with the interrupt destination CPU number, the accumulated number of times of interrupts, the preceding number of times of interrupts, the current number of times of interrupts, the increasing rate of number of times of interrupts, the interrupt destination CPU change effective flag (hereinafter, referred to as the “CPU change effective flag”), the number of times of interrupt destination CPU changes, and the number of times of load distribution processing after the effective flag OFF (hereinafter, referred to as the “number of times of load distribution processing”). The “interrupt destination CPU number” indicates the processor number specifying the interrupt destination processor. The “accumulated number of times of interrupts” indicates the accumulated number of times of interrupts from the point in time when the acquisition of statistical information has been started. The “preceding number of times of interrupts” indicates the number of times of interrupts (i.e., the previous accumulated number of times of interrupts) from a statistical information acquisition period immediately before the current period. The “current number of times of interrupts” indicates the current number of times of interrupts (i.e., the current accumulated number of times of interrupts) during a statistical information acquisition period. The “increasing rate of number of times of interrupts” indicates a value of the current accumulated number of times of interrupts divided by the preceding accumulated number of times of interrupts, that is, a value indicating the increasing rate of the number of times of interrupts. The “CPU change effective flag” indicates a flag indicating whether a change of interrupt destination processor is to be permitted or not. If the change is permitted, “ON (1)” is stored. Otherwise, “OFF (0)” is stored. The “number of times of interrupt destination CPU changes” indicates the number of times the interrupt destination processor has been changed. The “number of times of load distribution processing” is a setting which refers to the number of times of load distribution processing from the point in time when the interrupt destination CPU change effective flag has been turned OFF.

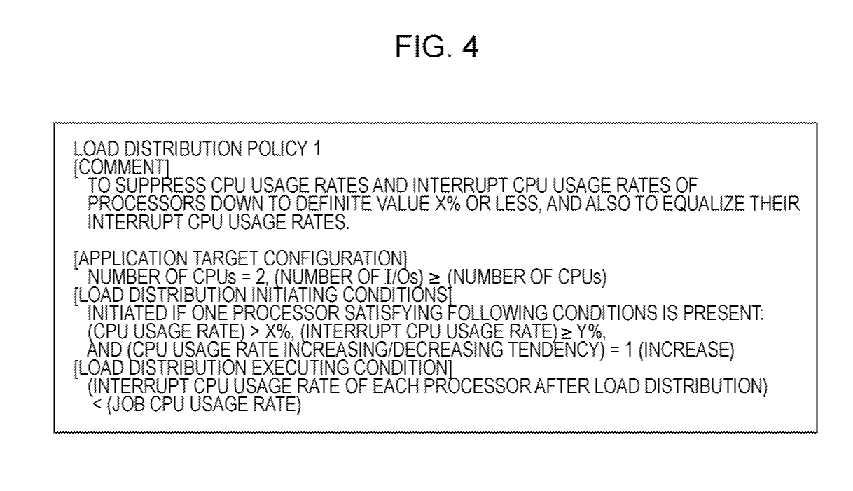

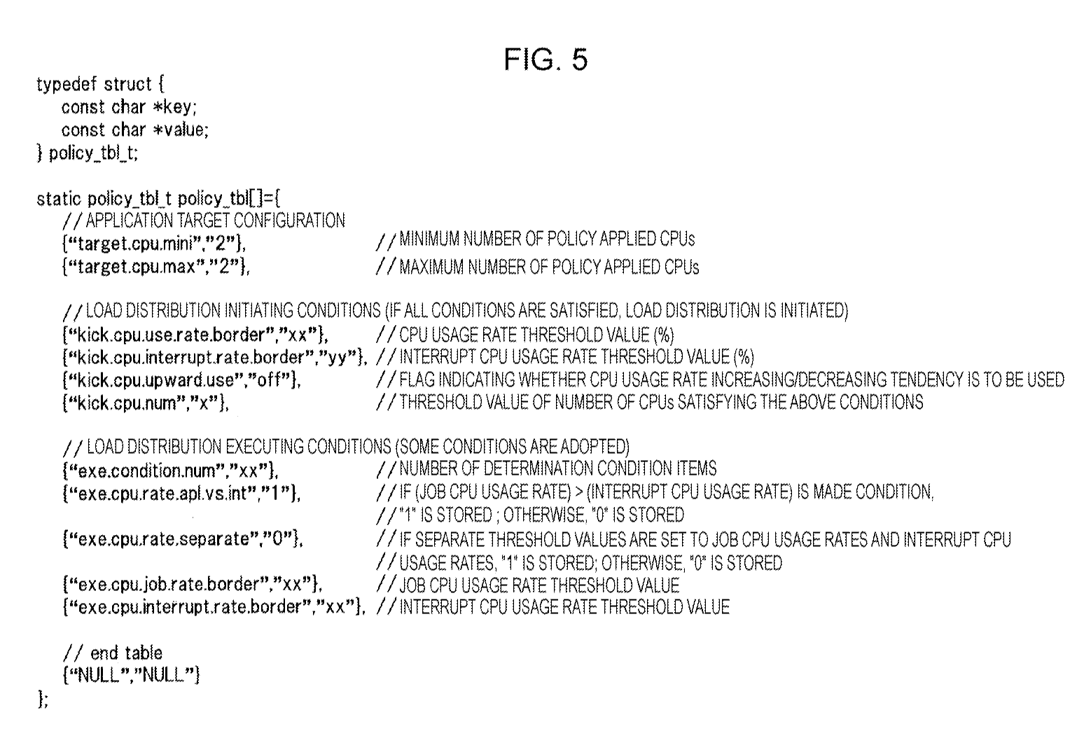

As illustrated in FIG. 4, at least one load distribution policy that defines an application target configuration, the load distribution initiating condition, and the load distribution executing condition is registered in the load distribution policy table 26. The “application target configuration” indicates the hardware configuration of a computer system to which the load distribution policy is applied, that is, numbers of processors and input/output devices. The “load distribution initiating condition” and the “load distribution executing condition” indicate respective conditions for initiating and executing load distribution defined by using various processor usage rates and the processor usage rate increasing/decreasing tendencies. As a method for implementing the load distribution policy, for example, a structure as illustrated in FIG. 5 may be used.

The statistical processing unit 12 acquires various pieces of statistical information at every first timing t₁ regarding each of the processors and each of the input/output devices, and updates the CPU statistical information table 22 and the I/O statistical information table 24. The load distribution policy selecting unit 14 selects a configuration conforming to the hardware configuration of the computer system at every second timing t₂ (t₂>t₁), out of the load distribution policies registered in the load distribution policy table 26. The load distribution execution determining unit 16 references the load distribution policy selected by the load distribution policy selecting unit 14, and determines whether the load distribution initiating condition and the load distribution executing condition are established or not. In response to the determination result, the load distribution execution determining unit 16 outputs a load distribution instruction to the interrupt destination CPU changing unit 20. The load distribution predicting unit 18 references the CPU statistical information table 22 and the I/O statistical information table 24, and predicts a load status of each of the processors after the load distribution through a simulation. The interrupt destination CPU changing unit 20, upon receipt of the load distribution instruction from the load distribution execution determining unit 16, changes the interrupt destination processor in response to the instruction content.

Here, a step of acquiring the load status are implemented by the statistical processing unit 12. A step of selecting the load distribution policy is implemented by the load distribution policy selecting unit 14. A step for determining whether a processor satisfying the load distribution initiating condition is present, and a step of outputting a message for urging improvement in the load distribution policy are implemented by the load distribution execution determining unit 16. A step for determining a processor and an input/output device satisfying the load distribution executing condition are implemented by the load distribution predicting unit 18. A step of changing the interrupt destination processor is implemented by the interrupt destination CPU changing unit 20.

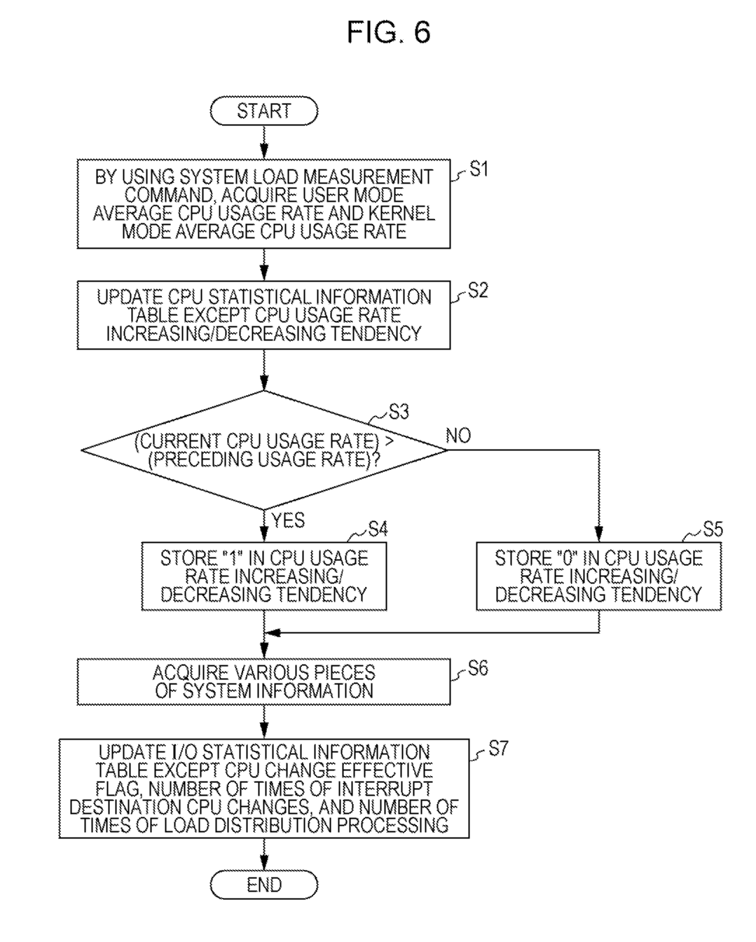

FIG. 6 illustrates a statistical processing content executed at every first timing t₁ in the statistical processing unit 12.

In step 1 (abbreviated as “S1” in the figure, and the same is applicable hereinafterby using, for example, a system load measurement command, a user mode average CPU usage rate and a kernel mode average CPU usage rate are acquired for each processor.

In step 2, in the CPU statistical information table 22 of each of the processors, fields except the CPU usage rate increasing/decreasing tendency are updated. That is, the user mode average CPU usage rate and the kernel mode average CPU usage rate are included in the job CPU usage rate and the interrupt CPU usage rate, respectively. Furthermore, after the current CPU usage rate has been stored in the preceding CPU usage rate, the sum of the job CPU usage rate and the interrupt CPU usage rate is stored in the current CPU usage rate.

In step 3, regarding the CPU statistical information table 22 of each of the processors, it is determined whether or not the current CPU usage rate is larger than the preceding CPU usage rate. If the current CPU usage rate is larger than the preceding CPU usage rate (“Yes” in step 3), the process advances to step 4, where “1” (increase) is stored as the CPU usage rate increasing/decreasing tendency. On the other hand, if the CPU usage rate is equal to or smaller than the preceding CPU usage rate (“No” in step 3), the process advances to step 5, where “0” (maintenance of the status quo or decrease) is stored as the CPU usage rate increasing/decreasing tendency.

In step 6, various pieces of system information from a system information storage region are acquired for each of the input/output devices.

In step 7, based on the various pieces of system information, all fields except the CPU change effective flag, the number of times of interrupts destination CPU changes, and the number of times of load distribution processing in the I/O statistical information table 24 are updated. That is, based on an affinity value of the system information, an interrupt destination CPU number is set, and, based on the number of times of interrupts, the accumulated number of times of interrupts is updated. Moreover, after the current number of times of interrupts has been stored as the preceding number of times of interrupts, the number of times of interrupts of system information decremented by the accumulated number of times of interrupts is stored as the current number of times of interrupts. Furthermore, the increasing rate of number of times of interrupts is updated based on the current number of times of interrupts divided by the preceding number of times of interrupts.

According to such statistical processing, at every first timing t₁ after the load distribution apparatus 10 has been started, statistical information indicating load statuses of each of the processors and each of the input/output devices is acquired. Because the CPU usage rate increasing/decreasing tendency and the increasing rate of number of times of interrupts are stored in this statistical information, the statistical information may be utilized as data predicting a processor load after load distribution.

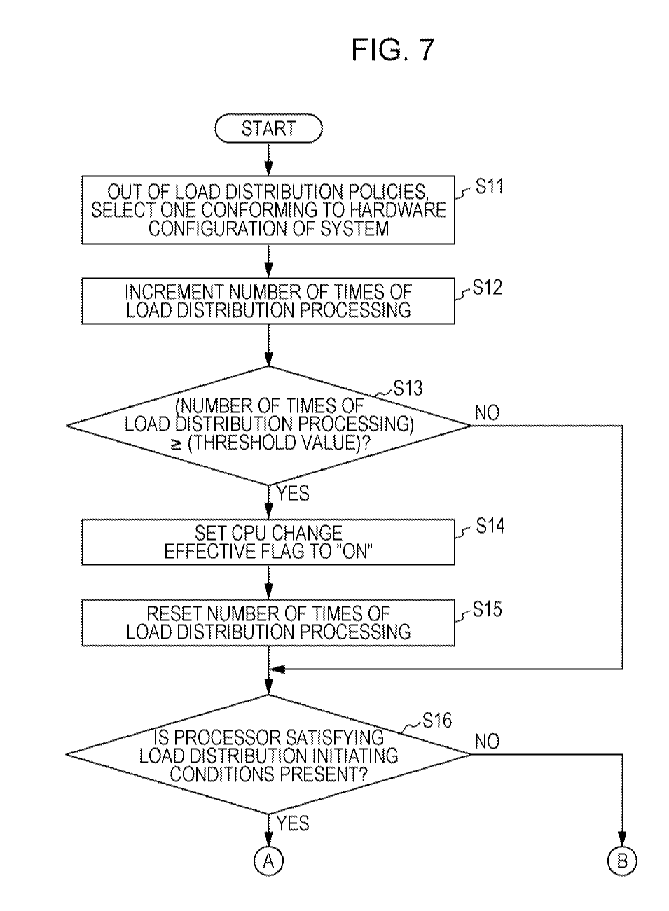

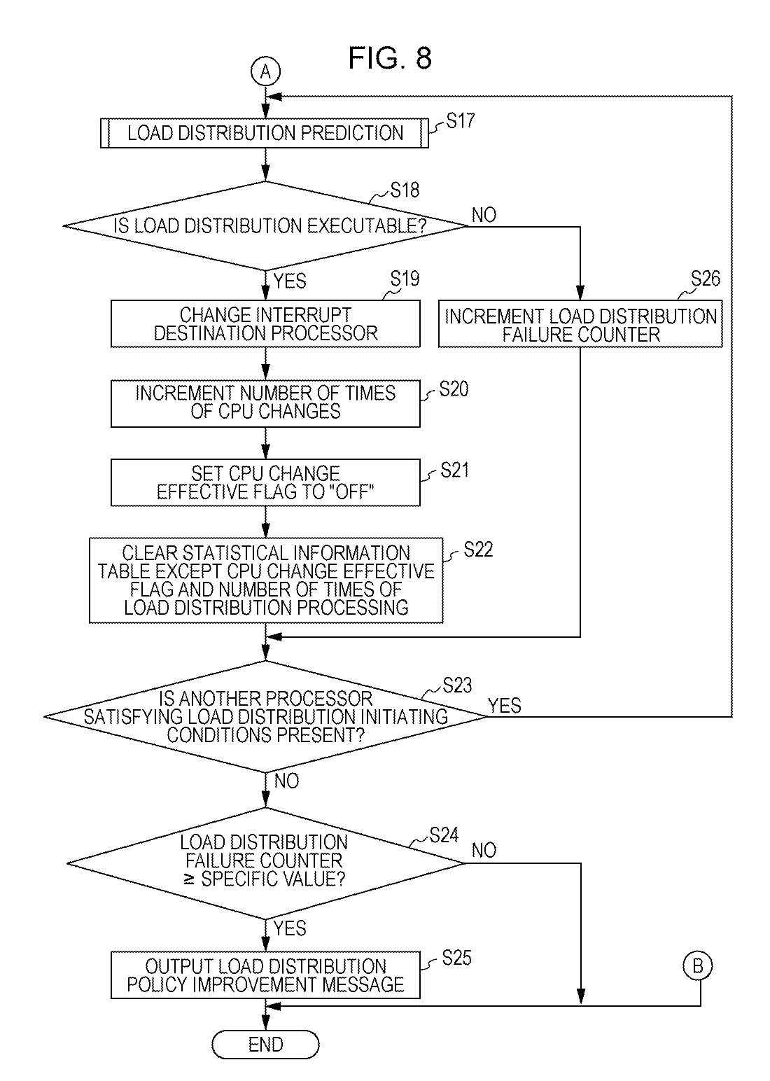

FIGS. 7 and 8 illustrate content of load distribution processing executed at every second timing t₂ by the load distribution policy selecting unit 14, the load distribution execution determining unit 16, and the interrupt destination CPU changing unit 20.

In step 11, a configuration conforming to the hardware configuration of the computer system is selected from the load distribution policy registered in the load distribution policy table 26. That is, content of the application target configuration of the load distribution policy is sequentially referenced to select a configuration conforming to the number of processors and the number of input/output devices of the computer system.

In step 12, the number of times of load distribution processing for each of the input/output devices in the I/O statistical information table 24 is incremented.

In step 13, it is determined whether or not the number of times of load distribution processing for each of the input/output devices is a specific threshold value or more. Here, the threshold value is used for controlling the number of changes of the processors to be interrupted by input/output devices, and is set to, for example, a natural number 2 or more that is commensurate with the throughput of the computer system. If the number of times of load distribution processing isequal to or greater than the threshold value (“Yes” in step 13), the process advances to step 14. On the other hand, if the number of times of load distribution processing is less than the threshold value (“No” in step 13), the process advances to step 16.

In step 14, the CPU change effective flag in the I/O statistical information table 24 is set to “ON (1)” for the input/output device of which the number of times of load distribution processing is equal to or greater than the threshold value.

In step 15, the number of times of load distribution processing in the I/O statistical information table 24 is reset for the input/output device of which the number of times of load distribution processing is equal to or greater than than the threshold value.

In step 16, the CPU statistical information table 22 is referenced to determine whether or not a processor satisfying the load distribution initiating condition of the load distribution policy is present. If a processor satisfying the load distribution initiating condition is present (“Yes” in step 16), the process advances to step 17. Otherwise (“No” in step 16), the current load distribution processing is finished.

In step 17, a pointer storing the number of processor satisfying the load distribution initiating condition and a pointer storing the numbers of processor and input/output device that execute load distribution, are each used as an argument to call a subroutine for performing a load distribution prediction. In the subroutine for performing a load distribution prediction, the numbers of processors and input/output devices that execute load distribution are set as argument pointers, and a value indicating whether or not load distribution is executable is set as a return value.

In step 18, it is determined that a load distribution is executable based on the return value of the subroutine performing a load distribution prediction. If the load distribution is executable (“Yes” in step 18), the process advances to step 19. Otherwise (“No” in step 18), the process advances to step 26, where a load distribution failure counter is incremented, and then the process advances to step 23.

In step 19, based on the processor number and the input/output device number that have been set as the argument pointers, an interrupt destination processor is actually changed.

In step 20, the number of times of interrupt destination CPU changes in the I/O statistical information table 24 is incremented for the input/output device that changed the interrupt destination processor.

In step 21, in order to inhibit the interrupt destination processor from being frequently changed, the CPU change effective flag of the I/O statistical information table 24 is set to “OFF (0)” for the input/output device that changed the interrupt destination processor.

In step 22, all fields other than the CPU change effective flag and the number of times of load distribution processing are cleared in the I/O statistic information table 24 for the input/output device that changed the interrupt destination processor.

In step 23, it is determined whether or not any other processor satisfying the load distribution initiating condition is present. If no other processor satisfying the load distribution initiating condition is present (“No” in step 23), the process advances to step 24. On the other hand, if another processor satisfying the load distribution initiating condition is present (“Yes” in step 23), the process returns to step 17.

In step 24, it is determined whether or not the load distribution failure counter is equal to or greater than a specific value (e.g., 10). If the load distribution failure counter is equal to or greater than the specific value (“Yes” in step 24), the process advances to step 25, where a message for urging an improvement in the load distribution policy is outputted to a system log or the like. On the other hand, if the load distribution failure counter is less than the specific value (“No” in step 24), the current load distribution processing is finished.

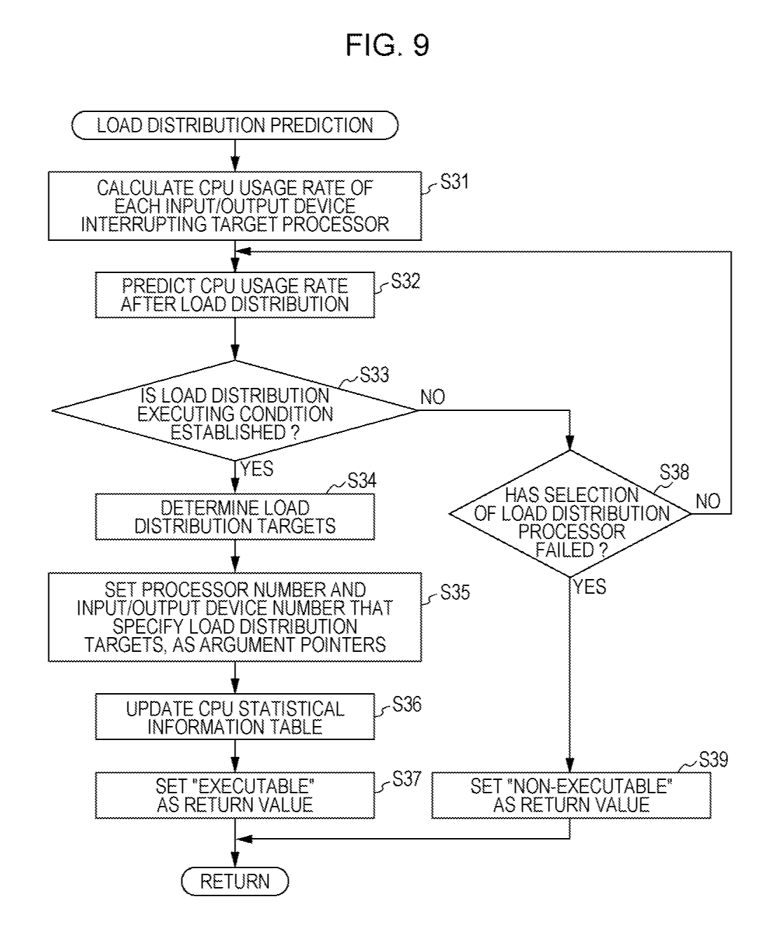

FIG. 9 illustrates a subroutine for performing a load distribution prediction.

In step 31, the CPU statistical information table 22 and the I/O statistical information table 24 are referenced to calculate the CPU usage rate of each of the input/output devices interrupting a processor specified by the processor number set as the argument pointer (hereinafter, referred to as a “target processor”). That is, interrupt destination CPU numbers in the I/O statistical information table 24 are referenced to specify input/output devices interrupting the target processor (hereinafter, referred to as “target input/output devices”). Moreover, the CPU usage rate for each of the target input/output devices is calculated by multiplying the interrupt CPU usage rate of the target processor by a value obtained by dividing the accumulated number of times of interrupts from a particular input/output device by a total accumulated number of times of interrupts of the target processor. Here, the total accumulated number of times of interrupts of the target processor is obtained by adding up the number of times of interrupts of all of the target input/output devices. Here, in order to enhance the prediction accuracy with respect to the CPU usage rate, it is desirable to weight the CPU usage rate of each of the target input/output devices in consideration of the rate of increase of the number of times of interrupts.

In step 32, the CPU usage rate of the target processor after load distribution is predicted through simulation. That is, one of the target input/output devices whose CPU usage rate is a maximum and whose CPU change effective flag is ON is selected. In processing in the second and subsequent times, input/output devices that have already been selected are excluded. A processor whose job CPU usage rate and interrupt CPU usage rate are the lowest is selected from among all processors. Furthermore, the CPU usage rate of the selected input/output device is added to the interrupt CPU usage rate of the selected processor. Also, the CPU usage rate of the selected input/output device is subtracted from the interrupt CPU usage rate of the target processor.

In step 33, when the load distribution through the simulation is executed in step 32, it is determined whether or not the load distribution executing condition in the load distribution policy is established. If the load distribution policy is established (“Yes” in step 33), the process advances to step 34. Otherwise (“No” in step 33), the process advances to step 38.

In step 34, the processor and the input/output device by which the load distribution executing condition is established are selected as load distribution targets.

In step 35, processor numbers and input/output device numbers that specify the load distribution targets are set as the argument pointers.

In step 36, the interrupt CPU usage rate in the CPU statistical information table 22 is updated based on the processor CPU usage rates predicted in step 32.

In step 37, “executable” is set as a return value of the subroutine.

In step 38, it is determined whether or not the selection of a processor executing the load distribution has failed; that is, it is determined whether the load distribution executing condition is established or not based on the predeiction results of all target input/output devices. If the selection of the processor has failed (the load distribution has failed (“Yes” in step 38), the process advances to step 39, and “non-executable” is set as a return value. Otherwise (“No” in step 38), the process returns to step 32.

According to this load distribution processing, a load distribution policy conforming to the hardware configuration is selected. Moreover, by utilizing the statistical information on processors and input/output devices, it is determined whether or not a processor satisfying the load distribution initiating condition defined by the load distribution policy is present. If a processor satisfying the load distribution initiating condition is present, the CPU usage rate after load distribution is predicted through the simulation for each of the input/output devices interrupting the processor. Then, based on the CPU usage rate after load distribution, a processor and an input/output device by which the load distribution executing condition defined by the load distribution policy is established, are determined. Thereafter, statistical information on the processor and the input/output device is updated as appropriate, and the interrupt destination processor of the input/output device is changed.

According to this load distribution processing, the processor and the input/output device are determined as load distribution targets based on the simulation result that predicted the processor load after load distribution. This avoids the load from being unevenly distributed among only a few processors after the load distribution, and helps reduce performance degradation of the computer system. Moreover, a load distribution policy conforming to the hardware configuration of the computer system is selected, and therefore, the load distribution processing using the load distribution policy may help improve performance of the computer system.

Furthermore, after having determined the processor and the input/output device as load distribution targets, the processor is excluded from becoming a determination target until a third timing longer than the second timing has elapsed, so that it is possible to inhibit the interrupt destination processor of the input/output device from being frequently changed. Moreover, when a processor and an input/output device satisfying the load distribution executing condition are unable to be determined after a specific number of attempts, a message urging an improvement in the load distribution policy is outputted, so that the load distribution policy may be modified as appropriate.

Next, in order to facilitate understanding of the load distribution apparatus 10, examples of a computer system with two processors and four input/output devices will be described below.

### FIRST EXAMPLE

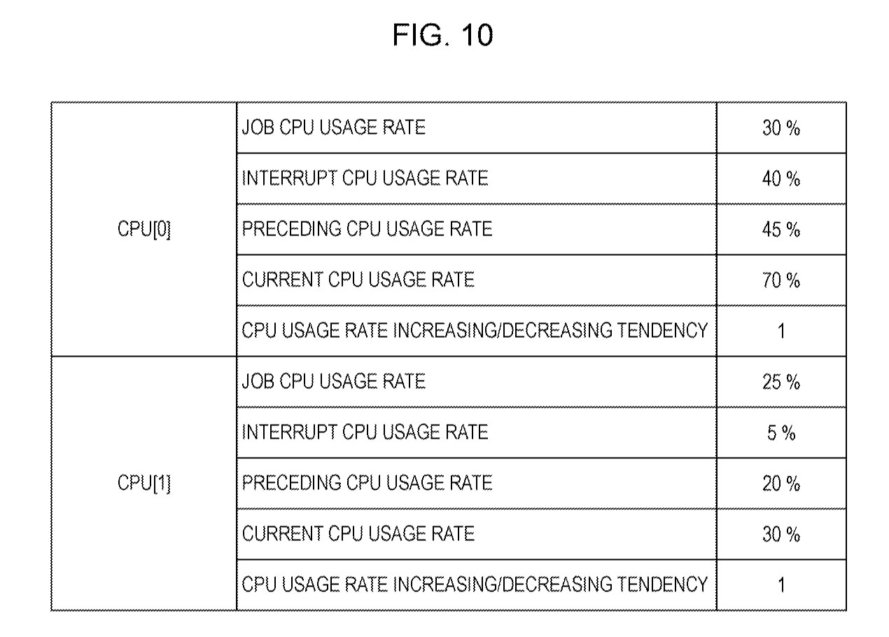

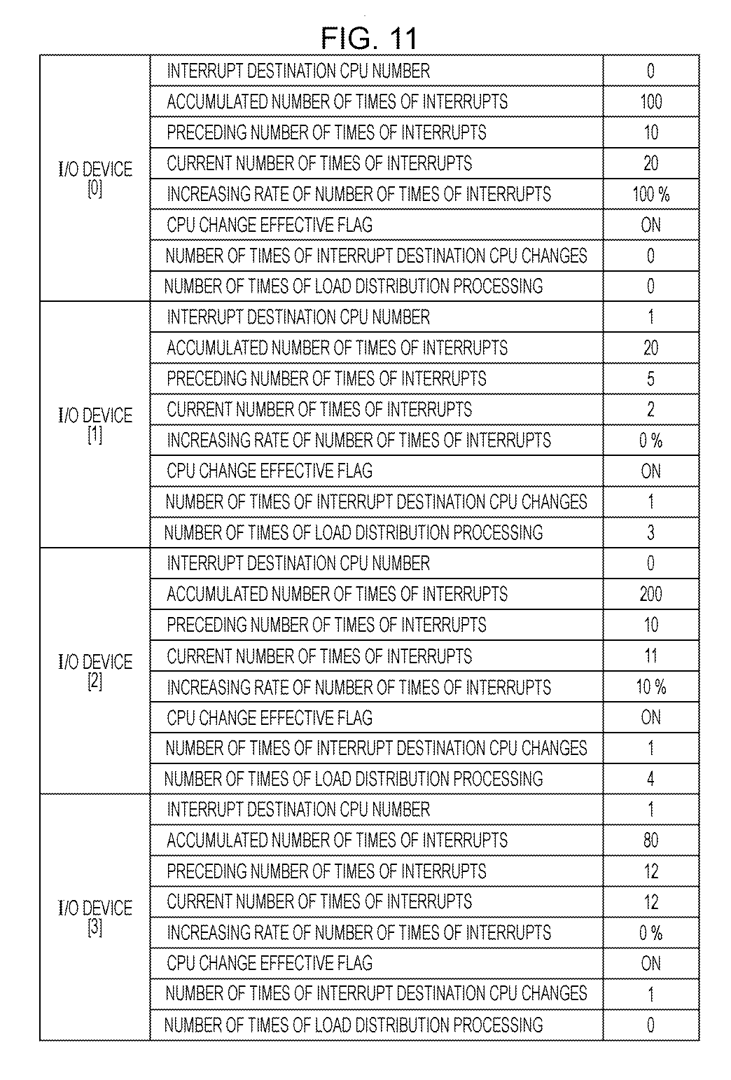

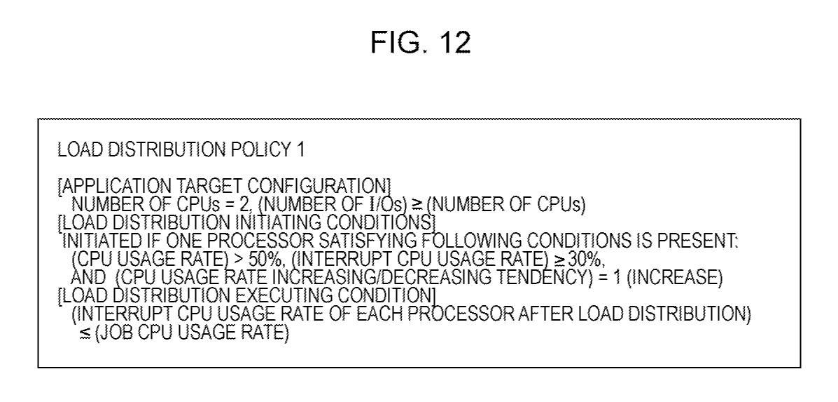

At the startup of load distribution processing, it is assumed that the processor load status registered in the CPU statistical information table 22 is the status illustrated in FIG. 10, and that the input/output device load status registered in the I/O statistical information table 24 is the status illustrated in FIG. 11. It is further assumed that the load distribution policy 1 illustrated in FIG. 12 has been registered in the load distribution policy table 26a.

Upon startup of load distribution processing, the load distribution policy 1 conforming to the hardware configuration of the computer system is selected. When the processor load status is referenced, it is recognized that the current CPU usage rate is 70%, the interrupt CPU usage rate is 40%, and the CPU usage rate increasing/decreasing tendency is 1 (increase) for the processor 0. This indicates that the processor 0 satisfies the load distribution initiating condition. Now, a load distribution prediction is performed with the processor 0 as a target. First, by using the formula: “(CPU usage rate)=(interrupt CPU usage rate)×(accumulated number of times of interrupts)/(total accumulated numbers of times of interrupts)”, CPU usage rates of input/output devices 0 and 2 interrupting the processor 0 are calculated as follows:

(CPU usage rate of input/output device 0)=40×(100/(100+200))≅13[%]

(CPU usage rate of input/output device 2)=40×(200/(100+200))≅27[%]

Then, regarding the CPU usage rate of input/output devices 0 and 2, weighting is made in consideration of the increasing rate of the number of times of interrupts as below. A rule that when the increasing rate of number of times of interrupts exceeds 50%, weighting coefficient=0.5 is adopted, is applied.

(CPU usage rate of input/output device 0)=13+13×0.5≅20[%]

(CPU usage rate of input/output device 2)=27+27×0.1≅30[%]

The input/output device 2 whose CPU usage rate is the highest and whose CPU change effective flag is ON is selected out of the input/output devices 0 and 2. Furthermore, the processor 1 whose job CPU usage rate and interrupt CPU usage rate are the lowest is selected out of all the processors. The CPU usage rate (30%) of the input/output device 2 is added to the interrupt CPU usage rate (5%) of the processor 1, thereby predicting an interrupt CPU usage rate (35%) of the processor 1 when the interrupt destination of the input/output device 2 is changed to the processor 1. On the other hand, the CPU usage rate (30%) of the input/output device 2 is subtracted from the interrupt CPU usage rate (40%) of the processor 0, thereby predicting an interrupt CPU usage rate (10%) of the processor 0 when the interrupt destination of the input/output device 2 is changed to the processor 1. Since “(interrupt CPU usage rate 10%<(job CPU usage rate 30%)” holds for the processor 0, the load distribution executing condition is established. However, regarding the processor 1, since “(interrupt CPU usage rate 30%)>(job CPU usage rate 25%)” holds, the load distribution executing condition is not established. Therefore, if the interrupt destination of the input/output device 2 is changed to the processor 1, the load distribution executing condition is not established, and the selection of the input/output device is redone.

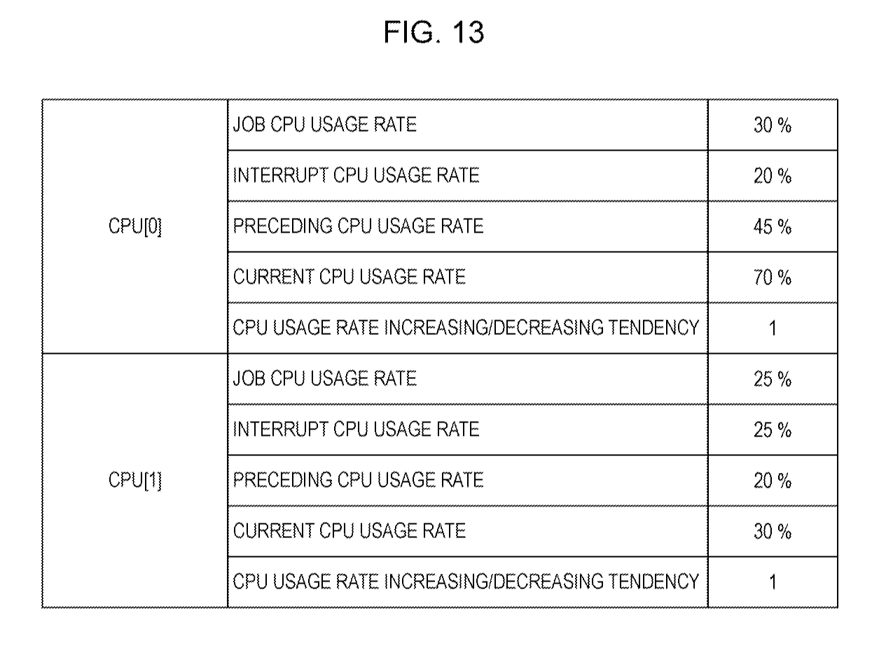

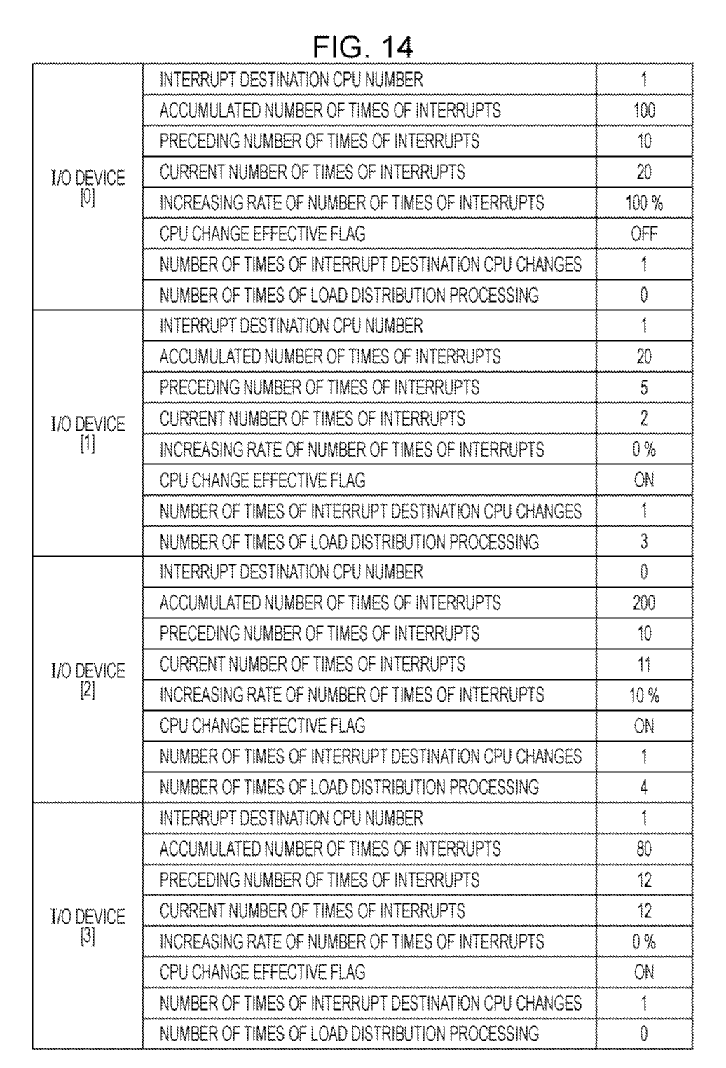

The input/output device 0 whose CPU usage rate is the second highest and whose CPU change effective flag is ON is selected out of the input/output devices 0 and 2. The CPU usage rate (20%) of the input/output device 0 is added to the interrupt CPU usage rate (5%) of the processor 1, thereby predicting an interrupt CPU usage rate (25%) of the processor 1 when the interrupt destination of the input/output device 0 is changed to the processor 1. On the other hand, the CPU usage rate (20%) of the input/output device 0 is subtracted from the interrupt CPU usage rate (40%) of the processor 0, thereby predicting an interrupt CPU usage rate (20%) of the processor 0 when the interrupt destination of the input/output device 0 is changed to the processor 1. Regarding the processor 0, “(interrupt CPU usage rate 20%)<(job CPU usage rate 30%)” holds, and also, regarding the processor 1, “(interrupt CPU usage rate 25%)=(job CPU usage rate 25%)” holds, so that the load distribution executing condition is established. Accordingly, the processor 1 and the input/output device 0 are determined as load distribution targets, and as illustrated in FIG. 13, these results are reflected into the load status in the CPU statistical information table 22. Moreover, the interrupt destination of the input/output device is changed to the processor 1, and as illustrated in FIG. 14, the interrupt destination CPU number, the CPU change effective flag, and the number of times of interrupt destination CPU changes of the input/output device 0 in the I/O statistical information table 24 are updated.

The CPU statistical information table 22 is again referenced to determine whether or not another processor satisfying the load distribution initiating condition of the load distribution policy 1 is present. Since no other processor satisfying the load distribution initiating condition is present, the load distribution processing is finished.

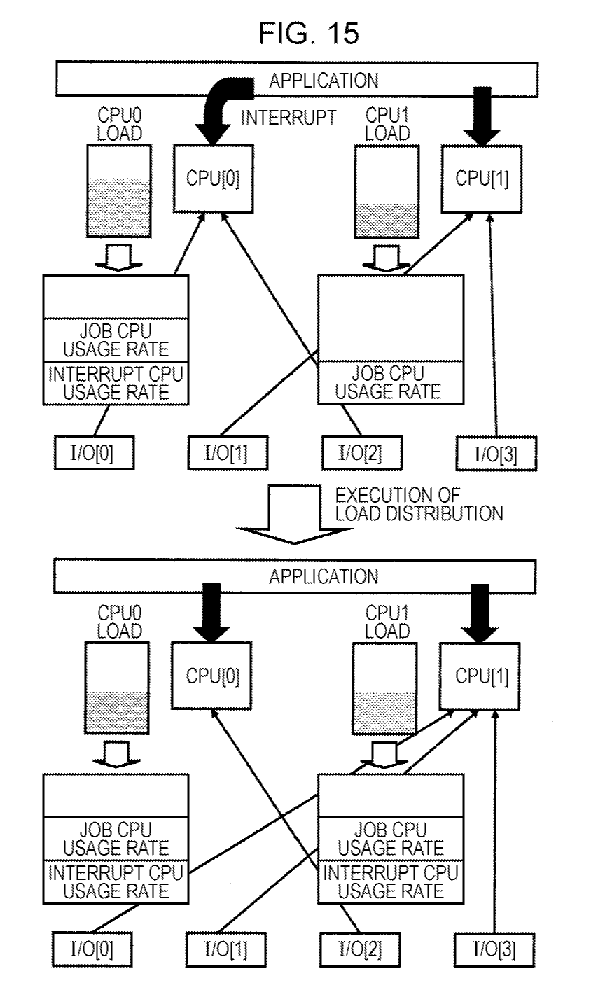

By performing such load distribution processing, the load distribution as illustrated in FIG. 15 is executed, thus allowing an improvement in performance of the computer system.

### SECOND EXAMPLE

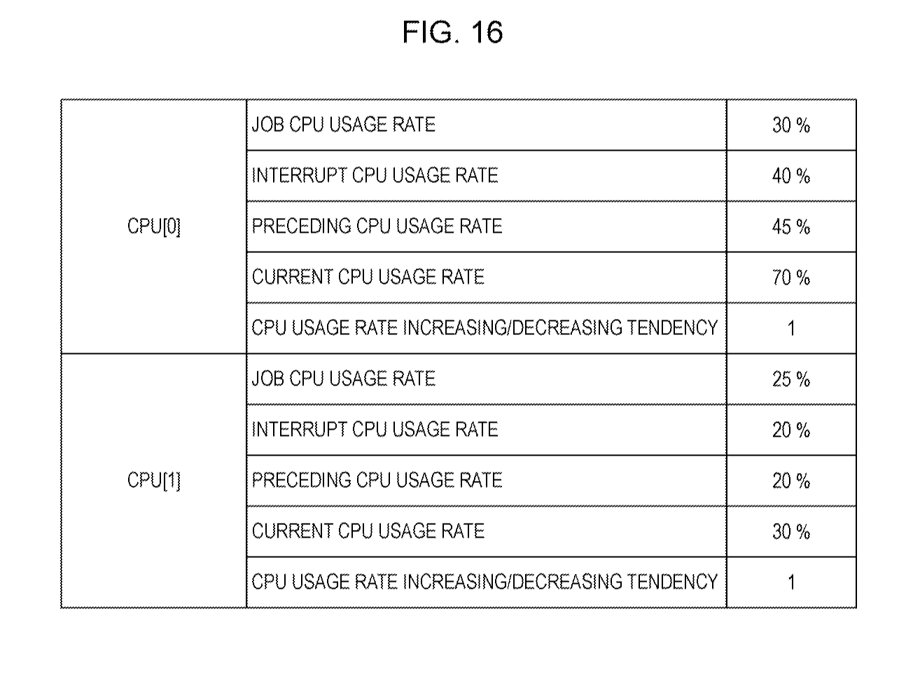

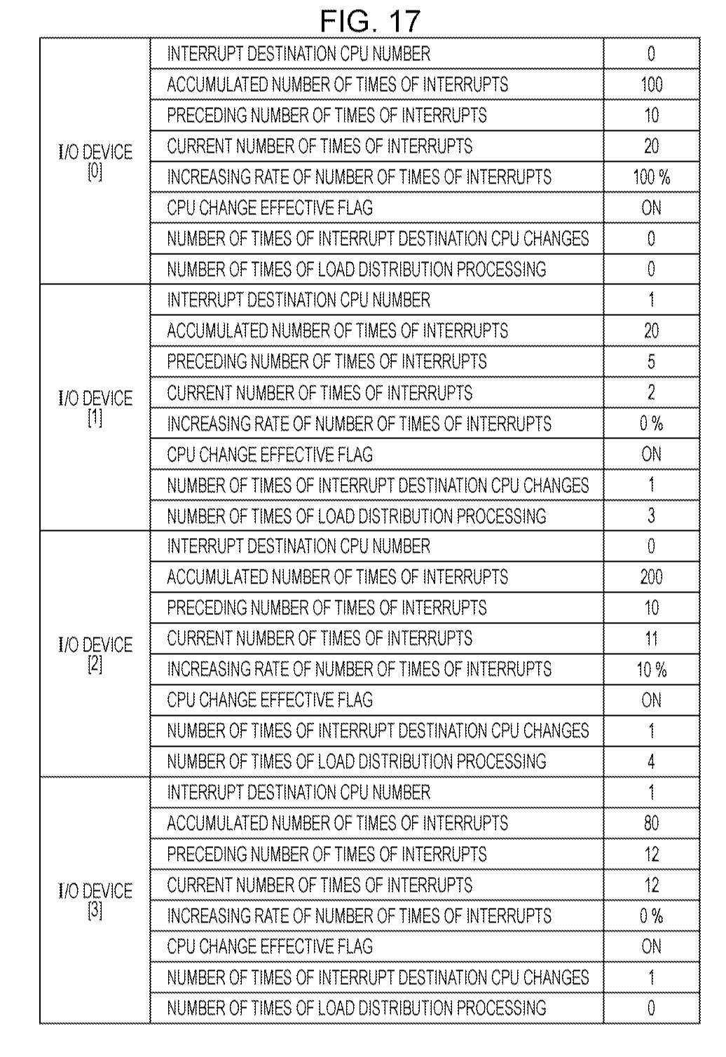

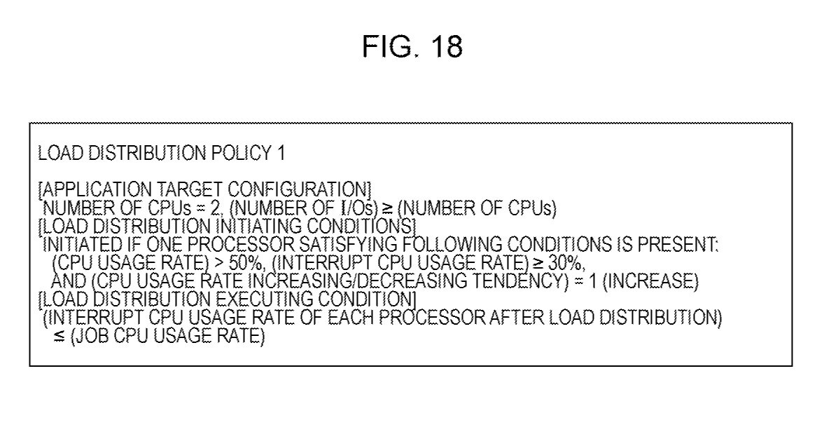

At the startup of load distribution processing, it is assumed that the processor load status registered in the CPU statistical information table 22 is the status illustrated in FIG. 16, and that the input/output device load status registered in the I/O statistical information table 24 is the status illustrated in FIG. 17. It is further assumed that the load distribution policy 1 illustrated in FIG. 18 has been registered in the load distribution policy table 26a.

Upon startup of the load distribution processing, the load distribution policy 1 conforming to the hardware configuration of the computer system is selected. When the processor load status is referenced, it is recognized that the current CPU usage rate is 70%, the interrupt CPU usage rate is 40%, and the CPU usage rate increasing/decreasing tendency is 1 (increase) for the processor 0. This indicates that the processor 0 satisfies the load distribution initiating condition. Now, a load distribution prediction is performed with the processor 0 as a target. First, by using the formula: “(CPU usage rate)=(interrupt CPU usage rate)×(accumulated number of times of interrupts)/(total accumulated numbers of times of interrupts)”, CPU usage rates of input/output devices 0 and 2 interrupting the processor 0 are calculated as follows:

(CPU usage rate of input/output device 0)=40×(100/(100+200))≅13[%]

(CPU usage rate of input/output device 2)=40×(200/(100+200))≅27[%]

Then, regarding the CPU usage rate of each of input/output devices 0 and 2, weighting is made in consideration of the increasing rate of number of times of interrupts as below. A rule that when the increasing rate of number of times of interrupts exceeds 50%, weighting coefficient=0.5 is adopted, is applied.

(CPU usage rate of input/output device 0)=13+13×0.5≅20[%]

(CPU usage rate of input/output device 2)=27+27×0.1≅30[%]

The input/output device 2 whose CPU usage rate is the highest and whose CPU change effective flag is ON is selected from the input/output devices 0 and 2. Furthermore, out of all processors, the processor 1 whose job CPU usage rate and interrupt CPU usage rate are the lowest is selected. The CPU usage rate (30%) of the input/output device 2 is added to the interrupt CPU usage rate (20%) of the processor 1, thereby predicting an interrupt CPU usage rate (50%) of the processor 1 when the interrupt destination of the input/output device 2 is changed to the processor 1. On the other hand, the CPU usage rate (30%) of the input/output device 2 is subtracted from the interrupt CPU usage rate (40%) of the processor 0, thereby predicting an interrupt CPU usage rate (10%) of the processor 0 when the interrupt destination of the input/output device 2 is changed to the processor 1. Since “(interrupt CPU usage rate 10%<(job CPU usage rate 30%)” holds for the processor 0, the load distribution executing condition is established. However, since “(interrupt CPU usage rate 50%)>(job CPU usage rate 25%)” holds for the processor 1, the load distribution executing condition is not established. Therefore, if the interrupt destination of the input/output device 2 is changed to the processor 1, the load distribution executing condition is not established, and so the selection of the input/output device is redone.

The input/output device 0 whose CPU usage rate is the second highest and whose CPU change effective flag is ON is selected from the input/output devices 0 and 2. The CPU usage rate (20%) of the input/output device 0 is added to the interrupt CPU usage rate (20%) of the processor 1, thereby predicting an interrupt CPU usage rate (40%) of the processor 1 when the interrupt destination of the input/output device 0 is changed to the processor 1. On the other hand, the CPU usage rate (20%) of the input/output device 0 is subtracted from the interrupt CPU usage rate (40%) of the processor 0, thereby predicting an interrupt CPU usage rate (20%) of the processor 0 when the interrupt destination of the input/output device 0 is changed to the processor 1. Since “(interrupt CPU usage rate 20%)<(job CPU usage rate 30%)” holds for the processor 0, the load distribution executing condition is established. However, since “(interrupt CPU usage rate 40%)>(job CPU usage rate 25%)” holds for the processor 1, the load distribution executing condition is not established.

In this way, load distribution predictions are performed for the input/output devices 0 and 2 interrupting the processor 0, but since there is no processor or input/output device satisfying the load distribution executing condition of the load distribution policy 1, the load distribution is determined to be “non-executable”, thus finishing the load distribution processing.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A recording medium with a load distribution program recorded therein for a computer system including a plurality of processors and a plurality of input/output devices, the program causing the computer to execute:
acquiring, at a first timing, a processor load status including a processor usage rate of an application job, a processor usage rate of an interrupt from at least one of the input/output devices, and a processor usage rate increasing/decreasing tendency for each of the processors; and, for each of the input/output devices, an input/output device load status including an interrupt destination processor and an accumulated number of times of interrupts;
referencing, at every second timing, a load distribution policy that defines a load distribution initiating condition and a load distribution executing condition for distributing interrupts from at least one of the input/output devices among the processors, and using the processor usage rate of the application job, the processor usage rate of the interrupt from the at least one of the input/output devices, and the processor usage rate increasing/decreasing tendency; and determining whether or not a processor satisfying the load distribution initiating condition is present based on the processor load status;
referencing the processor load statuses and input/output device load statuses when a processor satisfying the load distribution initiating condition is present; calculating processor usage rates of all input/output devices interrupting the processor; and determining a processor and an input/output device satisfying the load distribution executing condition based on the calculated processor usage rate; and
changing the interrupt destination processor of the input/output device satisfying the load distribution executing condition.

2. The recording medium according to claim 1, wherein the load distribution program stored in the recording medium causes the computer to further execute the following processing comprising:
defining in the load distribution policy, a hardware configuration of the computer system that is an application target; and
selecting, for the computer system, a load distribution policy conforming to the hardware configuration, out of a plurality of load distribution policies.

3. The recording medium according to claim 1, wherein the load distribution program stored in the recording medium causes the computer to further execute the following processing comprising:
weighting the processor usage rate of at least one of the input/output devices, in accordance with the increasing rate of the number of times of interrupts.

4. The recording medium according to claim 1, wherein the load distribution program stored in the recording medium causes the computer to further execute the following processing comprising:
when determining a processor and an input/output device that satisfy the load distribution executing condition, excluding the processor from a determination target until a third timing longer than the second timing elapses, after the processor satisfying the load distribution executing condition has been determined.

5. The recording medium according to claim 1, wherein the load distribution program stored in the recording medium causes the computer to further execute the following processing comprising:
causing the computer system to implement outputting a message for urging an improvement in the load distribution policy when the processor and the input/output device that satisfy the load distribution executing condition are unable to be determined a specific number of times.

6. A load distribution apparatus in a computer system including a plurality of processors and a plurality of input/output devices, the load distribution apparatus comprising:
a load status acquisition unit for acquiring, every first timing, for each of the processors, a load status including a processor usage rate of an application job, a processor usage rate of an interrupt from at least one of the input/output devices, and a processor usage rate increasing/decreasing tendency; and, for each of the input/output devices, an input/output device load status including an interrupt destination processor and an accumulated number of times of interrupts;
a determination unit for referencing, at every second timing, a load distribution policy that defines a load distribution initiating condition and a load distribution executing condition for distributing interrupts from at least one of the input/output devices among the processors, using the processor usage rate of the application job, the processor usage rate of the interrupt from the at least one of the input/output devices, and the processor usage rate increasing/decreasing tendency; and determining whether or not a processor satisfying the load distribution initiating condition is present based on the processor load status;
a decision unit for referencing the processor load statuses and input/output device load statuses when a processor satisfying the load distribution initiating condition is present; for calculating processor usage rates of all the input/output devices interrupting the processor; and for deciding a processor and an input/output device satisfying the load distribution executing condition based on the calculated processor usage rate; and
an interrupt destination changing unit for changing an interrupt destination processor of the input/output device satisfying the load distribution executing condition.
